(19) United States
(12) Patent Application Publication
(10) Pub. No.: US 2017/0308826 A1
(43) Pub. Date: Oct. 26, 2017

(54) Childcare Facility Platform, System and Method

(71) Applicant: MiCare Global Pty Ltd, Brisbane (AU)

(72) Inventor: Sharyn Fewster, Wilston (AU)

(21) Appl. No.: 15/191,496

(22) Filed: Jun. 23, 2016

(30) Foreign Application Priority Data
Apr. 26, 2016 (AU) 2016901541

(51) Int. Cl. G06Q 10/06

(52) U.S. Cl. CPC G06Q 10/0631

(57) ABSTRACT

A computer web platform, system and method to identify and fulfil a vacancy at a childcare facility in which a first parent of an absent child is permitted to onsale a vacancy to a second parent in need of childcare in a peer-to-peer relationship between parents. Involvement by the childcare facility may be limited to final acceptance of a placement after an agreement amongst the first and second parents.

### FIELD OF THE INVENTION

The present disclosure relates to facility platform, system and method of identifying and fulfilling vacancies at a childcare facility.

### BACKGROUND OF INVENTION

Access to reliable, flexible, childcare services is a prime inhibitor for parents, and in most cases woman, participating in the workforce. While accessibility to flexible childcare is well documented as having a direct impact upon workforce participation, in any one day there may be approximately 8% absences in childcare centers across Australia.

Waitlists can be difficult to manage due to parents not updating any change in status or details, as well as the basic spreadsheet types of approaches adopted by childcare centers to match waitlists and absenteeism. The process of identifying an available child on the waitlist at a childcare facility to fill the spot of the absent child may be tedious and time consuming.

There is little incentive for childcare management to fill an absent spot, as in most cases the center management is not profit driven. Absent spots more often than not, go unfilled for the day.

### SUMMARY

In one exemplary embodiment, the present disclosure is directed to a method for filling a vacancy at a childcare facility. The method includes creating a first profile on a database. The first profile includes contact data of a first parent or guardian of a child who is enrolled at the childcare facility. The method includes creating a second profile on the database. The second profile includes contact data of a second parent or guardian of a child in need of childcare. The method includes receiving, from a personal computing device associated with the first parent or guardian, a notification that the enrolled child of the first parent or guardian will be absent during a time period in which the enrolled child is scheduled to attend the childcare facility. The method includes sending, to a personal computing device associated with the second parent or guardian, an alert notification of an available time period being vacated by the absence of the enrolled child without providing a parallel notification to a computing device associated with the childcare facility. The method includes receiving, from the personal computing device associated with the second parent or guardian, an acceptance notification that a child associated with the second parent or guardian will occupy at least a portion of the time period being vacated by the absent child. The method includes then receiving, from the computing device associated with the childcare facility, an authorization notification accepting a placement of the child of the second parent or guardian in lieu of the absent enrolled child.

The method may include sending confirmation to the personal computing device associated with the second parent or guardian that placement of the child of the second parent or guardian in lieu of the absent enrolled child has been accepted by the computing device associated with the child care facility.

The method may include a payment service process being initiated after the authorization notification is received. The payment service process may be for the second parent or guardian to pay a fee for the placement of the child of the second parent or guardian. At least a part of the fee may be paid to the first parent or guardian. At least part of the fee may be paid to an administrator of the method.

The method may include updating a place list, listing booked places at the childcare facility, with details of the child of the second parent or guardian attending in lieu of the absent enrolled child, after the authorization notification is received.

The alert notification may only be sent to the second parent or guardian if the child of the second parent or guardian meets certain criteria. The criteria may be that the child is within a defined age range. The criteria may be that the child ordinarily attends a specific class at the childcare facility.

In another exemplary embodiment, the present disclosure is directed to a childcare vacancy filling system including a central server having a database with a first profile including contact data of a first parent or guardian of a child who is enrolled at a childcare facility and a second profile including contact data of a second parent or guardian of a child in need of childcare. The childcare vacancy filling system includes a computing device associated with the childcare facility. The childcare vacancy filling system includes a personal computing device associated with the first parent or guardian. The central server is operable to receive a notification that the enrolled child of the first parent or guardian will be absent during a time period in which the enrolled child is scheduled to attend the childcare facility. The childcare vacancy filling system includes a personal computing device associated with the second parent or guardian. The central server is operable to send an alert notification to the personal computing device associated with the second parent or guardian of an available time period being vacated by the absence of the enrolled child without providing a parallel notification to the computing device associated with the childcare facility.

In another exemplary embodiment, the present disclosure is directed to a childcare vacancy filling platform including a central server accessible by computing devices over a network and software applications executed on the computing devices. The software applications are configured to prompt a first parent or guardian of a child who is enrolled at the childcare facility to create a first profile via the software application and save the first profile in a database of the server. The software applications are configured to prompt a second parent or guardian of a child in need of childcare to create a second profile via the software application and save the second profile in the database. The server is configured to receive, from a personal computing device associated with the first parent or guardian, a notification that the enrolled child of the first parent or guardian will be absent during a time period in which the enrolled child is scheduled to attend the childcare facility. The server is configured to send, to a personal computing device associated with the second parent or guardian, an alert notification of an available time period being vacated by the absence of the enrolled child without providing a parallel notification to a computing device associated with the childcare facility. The server is configured to receive, from the personal computing device associated with the second parent or guardian, an acceptance notification that a child associated with the second parent or guardian will occupy at least a portion of the time period being vacated by the absent child. The server is configured to then receive, from the computing device associated with the childcare facility, an authorization notification accepting a placement of the child of the second parent or guardian in lieu of the absent enrolled child.

In another exemplary embodiment, the present disclosure is directed to a method for filling a vacancy at a childcare facility. The method includes creating a first profile on a database. The first profile includes contact data of a first parent or guardian of a child who is enrolled at the childcare facility. The method includes creating a second profile on the database. The second profile includes contact data of a second parent or guardian of a child in need of childcare. The method includes receiving, from a personal computing device associated with the second parent or guardian, a pre-booking request for a placement at the childcare facility based on an unannounced absence of an enrolled child at the childcare facility. The method includes receiving, from a personal computing device associated with the first parent or guardian, an absence notification that the enrolled child of the first parent or guardian will be absent during a time period in which the enrolled child is scheduled to attend the childcare facility. The method includes sending, to the personal computing device associated with the second parent or guardian, an acceptance notification that the pre-booking request is fulfilled after receiving the absence notification from the personal computing device associated with the first parent or guardian.

The method may include initiating a payment service process after the acceptance notification is sent, for the second parent or guardian to pay a fee for the placement of the child of the second parent or guardian. At least part of the fee may be paid to the first parent or guardian.

The method may include updating a place list, listing booked places at the childcare facility, with details of the child of the second parent or guardian attending in lieu of the absent enrolled child, after the acceptance notification is sent.

In another exemplary embodiment, the present disclosure is directed to a childcare vacancy filling system including a central server having a database with a first profile including contact data of a first parent or guardian of a child who is enrolled at a childcare facility and a second profile including contact data of a second parent or guardian of a child in need of childcare. The system includes a computing device associated with the childcare facility. The system includes a personal computing device associated with the first parent or guardian. The central server is operable to receive, from the personal computing device associated with the second parent or guardian, a pre-booking request for a placement at the childcare facility based on an unannounced absence of an enrolled child at the childcare facility. The system includes a personal computing device associated with the second parent or guardian. The central server is operable to receive, from the personal computing device associated with the first parent or guardian, an absence notification that the enrolled child of the first parent or guardian will be absent during a time period in which the enrolled child is scheduled to attend the childcare facility. The central sever is configured to send, to the personal computing device associated with the second parent or guardian, an acceptance notification that the pre-booking request is fulfilled after receiving the absence notification from the personal computing device associated with the first parent or guardian.

It will be appreciated that reference herein to “preferred” or “preferably” is intended as exemplary only. As used herein, “configured” includes creating, changing, or modifying a program on a computer or network of computers so that the computer or network of computers behave according to a set of instructions. The programming to accomplish the various embodiments described herein will be apparent to a person of ordinary skill in the art after reviewing the present specification, and for simplicity, is not detailed herein. The programming may be stored on a computer readable medium, such as, but not limited to, a non-transitory computer readable storage medium (for example, hard disk, RAM, ROM, CD-ROM, USB memory stick, or other physical device), and/or the Cloud.

The reference to any prior art in this specification is not, and should not be taken as an acknowledgement or any form of suggestion that the prior art forms part of the common general knowledge in Australia or in any other country.

The claims as filed and attached with this specification are hereby incorporated by reference into the text of the present description.

### BRIEF DESCRIPTION OF THE DRAWINGS

FIG. 1 is a diagram of the functional elements of a system for filling a vacancy at a childcare facility in accordance with a preferred embodiment of the present disclosure.

FIG. 2 is a swim lane diagram of a method of filling a vacancy at a childcare facility in accordance with a preferred embodiment of the present disclosure, implemented as part of the system of FIG. 1.

FIG. 3 is a process diagram of a payment service process used by the system of FIG. 1 to conclude a financial transaction for filling the vacancy at the childcare facility.

FIG. 4 is swim lane diagram of another embodiment of a method of filling a vacancy at a childcare facility in accordance with a preferred embodiment of the present disclosure, implemented as part of the system of FIG. 1.

FIG. 5 is a flow diagram of a waitlisting process for the childcare facility, implemented on the system of FIG. 1.

FIG. 6 is a screenshot of a software application user interface, showing a calendar for selecting days when a child may be absent from the childcare facility of FIG. 1.

FIG. 7 is a screenshot of a software application user interface, showing a calendar with a day highlighted for acceptance to attend the childcare facility of FIG. 1.

FIG. 8 is a screenshot of a software application user interface showing a calendar and categories for different days of the calendar.

FIG. 9 is a screenshot of a user interface of a mobile device, showing a notification received of an offer for a child to attend the childcare facility of FIG. 1.

### DETAILED DESCRIPTION OF THE DRAWINGS

Alternative embodiments of the disclosure will be apparent to those of ordinary skill in the art from consideration of the specification. It is intended that the specification and examples be considered as exemplary only, with a true scope and spirit of the disclosure being indicated by the claims which follow. It will be understood that the term “comprising” is intended to have a broad, open meaning and not limited to a particular embodiment.

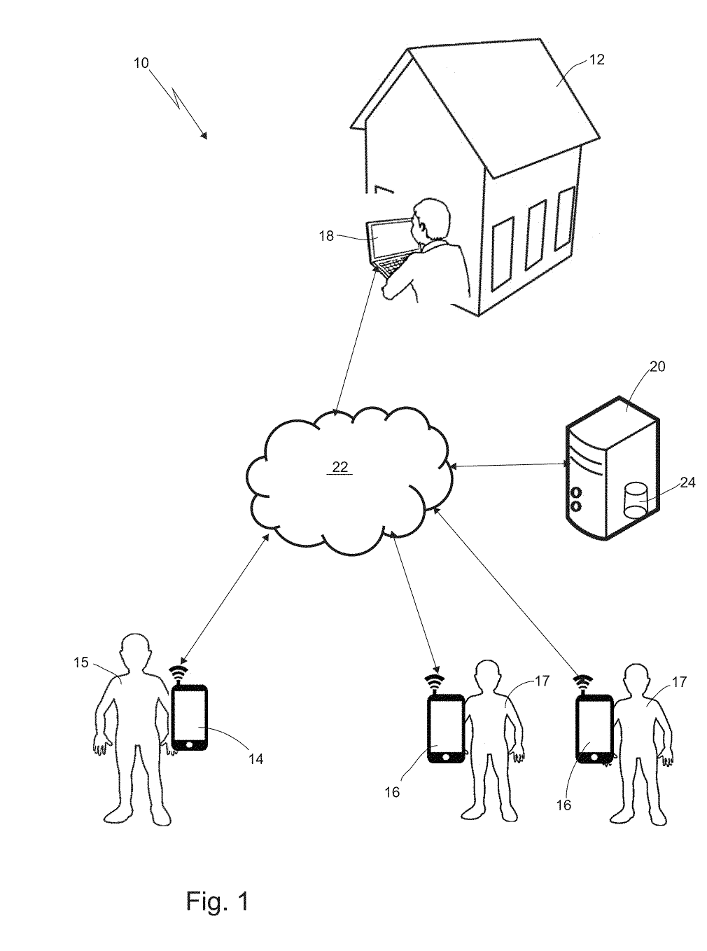

Referring to FIG. 1, a system for filling a vacancy at a childcare facility 12, is generally indicated by reference numeral 10. System 10 uses mobile application technology in communication with childcare specific enterprise management software hosted on a remote server to enable parents with children who are absent from childcare to on-sell the vacancy created by their child's absence for that day, or days, to parents with children in need of childcare.

System 10 includes a number of personal computing devices in the form of mobile devices 14 and 16. Mobile device 14 is associated with a first parent or guardian 15 of a child who is enrolled for regular childcare at childcare facility 12. Parent 15 has identified a day, or days, when their child will absent from scheduled childcare at childcare facility 12. Mobile device 16 is associated with a second parent or guardian 17 of a child who may be enrolled for regular childcare at childcare facility 12, or a second parent or guardian 17 of a child seeking a vacancy at childcare facility 12. Two parents 17 are depicted in FIG. 1, but it will be appreciated that many more parents will access system via their mobile devices 16 as described below.

System 10 includes a childcare computing device in the form of a computer terminal 18 associated with childcare facility 12. Computer terminal 18 may also be a mobile device. Multiple computer terminal 18 may be associated or registered with each child care facility 12.

System 10 includes a remote computer in the form of a central server 20 accessible by mobile devices 14, 16 and computer terminal 18 over a communications network 22. Server 20 includes a place list 24 of booked and available places at childcare facility 12. Server 20 has integrated messaging capability, such as the capability to send push notifications to mobile devices 14, 16 and to computer terminal 18.

System 10 includes an applications program, hereby termed the “Swap App”, executed on mobile devices 14, 16. Computer terminal 18 includes software executed on a processor of terminal 18 to interface or communicate with server 20.

Mobile devices 14, 16 are preferably commercially available, conventional mobile devices. Some of the basic functions of mobile devices 14, 16 preferably includes are: a touch sensitive graphical screen interface; a cellular radio transceiver; a GPS chip or receiver and associated antenna; an internal clock; and the ability to run or execute an application, including the Swap App. In the examples that follow, specific coding for the Swap App has been omitted for simplicity as a person of ordinary skill in the art would be able to understand and reproduce the functionality of the described embodiments without the need for discussion on particular coding. Although a mobile device is described as an example of a mobile communications device, the mobile communications device may be a PDA, a laptop, a tablet, a computer terminal, smartphone or any similar computing device.

The location for download of the Swap App may depend on the operating system of mobile device 14, 16. In one embodiment, mobile device 14, 16 is an iPhone®, manufactured and sold by Apple, Inc. and runs the iOS operating system. For phones running the Android operating system the Swap App may be downloaded from the Google Play store and similarly for phones running the Windows operating system the Swap App may be downloaded from the Windows store.

Communications network 22 includes a cellular or mobile broadband network and the internet to connect mobile device 14, 16 to server 20, and server 20 to computer terminal 18. Communications network 22 allows communication with server 20. Mobile devices 14, 16 connect to communications network 22 via a cellular or mobile broadband connection or via a wireless access point such as Wi-Fi.

Server 20 is a computer that can be accessed over network 22. Server 20 would typically include one or more CPU's and one or more high-capacity storage devices such as hard drives, solid-state drives, flash disks and the like. The hardware of server 20 may be any of a number of off-the-shelf servers known to those skilled in the art of computing. Server 20 stores place list information in place list 24 as discussed in more detail below. Server 20 includes payment administration or gateway software which manages payments as discussed in more detail below.

Server 20 may be managed or administrated by an administrator of system 10. Server 20 has system management software executed thereon which administrates system 10. Server 20 may be a physical server or a cloud based server. Server 20 may thus be hosted by a third party in either a shared or dedicated hosting arrangement.

The Swap App is typically used in combination with one or more processors of mobile device 14, 16, and where it is hosted, configures what might otherwise be a general purpose processor into a special purpose processor according to the functions and parameters of the Swap App. Preferably, the Swap App is downloaded to a computer readable medium such as a memory in mobile device 14, 16.

Parents 15, 17 who want to participate in the childcare vacancy swapping opportunity provided by system 10 are required to download and install the Swap App on their respective mobile devices 14, 16. The Swap App may be launched in a similar manner known for launching installed applications for the operating system of mobile device 14, 16.

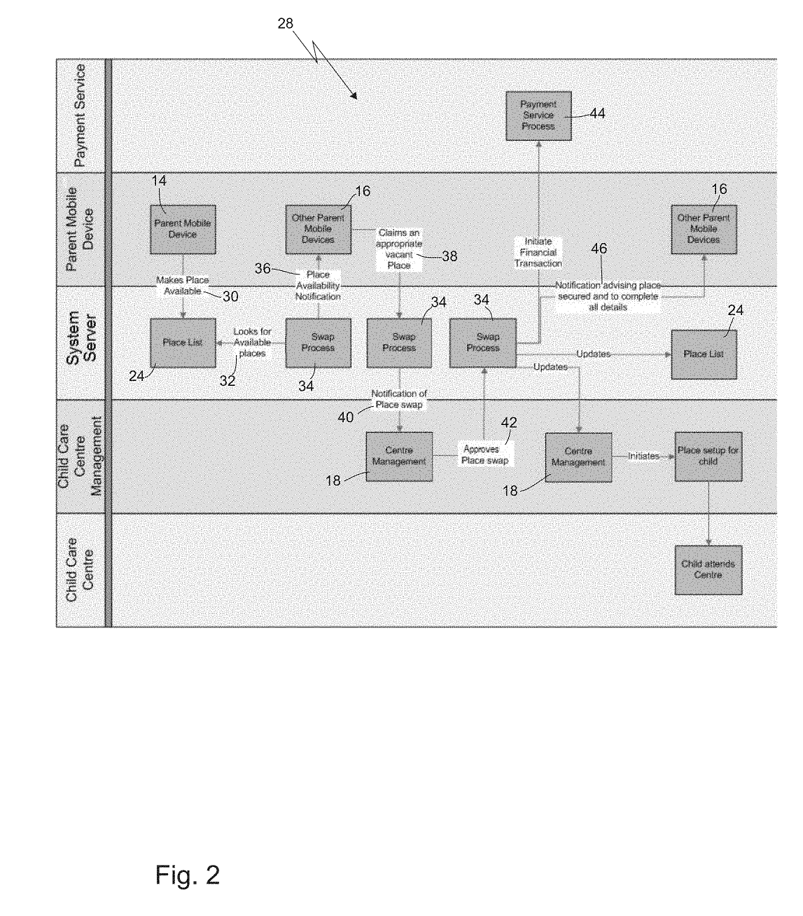

Referring to FIG. 2, a method filling a vacancy at childcare facility 12 is depicted as a flow process 28.

When parent 15 realises that their child will be absent from a scheduled attendance at day care, the parent notifies this absence to server 20 via the Swap App on mobile device 14. Notification of the absence makes a childcare place available for a particular day, or days, as indicated at step 30. Place list 24 is updated with the newly available childcare vacancy.

Parent 15 notifies system 10 of his child's absence by clicking on a calendar user interface presented by the Swap App on mobile device 14. The Swap App may prompt parent 15 to confirm the attendance of their child if they have not dropped their child off at the center 12 by a certain time of day.

Place list 24 is dynamically updated as parent 15 enters absence dates via the Swap App. Place list 24 may also be updated via center management if they receive a call or email regarding the absence of a child. A time period for absence indicated by parent 15 may be one full day, a number of consecutive days, a number or re-occurring weekdays, half days, or any other time period during which their child was scheduled to attend childcare facility 12.

System management software 34 executed on server 20 interrogates 32 place list 24 for available childcare vacancies. The interrogation 32 of place list 24 may happen automatically at set intervals, or is triggered to occur as soon as a change is made to place list 24. Interrogation 32 looks for vacancies in place list 24.

If an available place is identified by the system management software 34 then an alert notification in the form of a place availability notification 36 is sent to mobile devices 16 of parents 17.

Place availability notification 36 is sent to mobile devices 16 of all parents 17 who meet certain criteria as per their profile saved in server 20. The criteria may be the age of a child or the class the child is enrolled to attend at childcare facility 12.

For example, children attending or registered for childcare at facility 12 may be divided into age groups. A place availability notification 36 will be sent to parents with children in the same age group as the age group of the child who is booked childcare spot has been made available by their absence. Server 20 checks the age group of the child scheduled to be absent. Server 20 then looks up all other children in that age group attending or registered on a wait list for the childcare facility. Server 20 sends place availability notification 36 to all mobile devices 16 of parents 17 with children in the age group.

System management software 34 may check that a child is not already scheduled to attend the day(s) to be advised via place availability notification 36. Place availability notification 36 will not be sent to any parents 17 who have children already scheduled to attend childcare at childcare facility 12 on the days made available by parent 15. This will prevent unnecessary notifications to parents 17 who have no interest in the childcare availability for the days in place availability notification 36.

Children attending or registered for childcare at facility 12 may be also be divided into classes. Each class is generally associated with a physical room and caregivers are generally assigned to a class. It may be in the best interest for continuity and familiarity that an available place first be offered to parents 17 of other children attending the same class as the child scheduled to be absent.

A place availability notification 36 will be sent to parents with children in the same class as the child whose childcare spot has been made available. Server 20 checks the class of the child scheduled to be absent. Server 20 then looks up all other children in that class attending the childcare facility. Server 20 sends place availability notification 36 to all mobile devices 16 of parents 17 with children in that class who are not already scheduled to attend on the day(s) being made available by the absence.

System management software 34 may configure server 20 to send place availability notification 36 to children in the same class first. If the available places are not filled within a set or assigned time, server 20 may then send place availability notification 36 to children in the same age group, irrespective of class.

It is to be noted that place availability notification 36 is sent from server 20 without requiring approval from center management via terminal 18. For this reason no parallel place availability notification 36 is sent to terminal 18. Similarly, terminal 18 does not receive notification when a place is made available at step 30. System 10 is configured not to send unnecessary notifications or alerts to terminal 18.

Parent 17 claims, at step 38, a vacant place in response to place availability notification 36. Claim 38 is made by accepting the vacancy via the Swap App on mobile device 16 in response to place availability notification 36.

Acceptance of the vacancy is recorded by server 20. Server 20 sends an acceptance notification 40 to computer terminal 18 of childcare center 12.

Transaction acceptance notification 40 informs childcare center management that a vacancy made available by absence of a child has been claimed by parent 17. The transaction can only proceed if authorized by center management via terminal 18. This allows some control by center management at the stage where the childcare vacancy is ready to be filled, but for the authorization by center management.

Center management can authorize the transaction as indicated by authorization notification 42. Authorization notification 42 or alert is sent from computer terminal 18 to server 20.

Once authorization is received from computer terminal 18, server 20 proceeds to initiate a payment service process as indicated at 44, and as discussed in more detail below. Server 20 also notifies mobile device 16 of parent 17 at step 46 of the authorization of the request to claim the childcare vacancy. Server 20 updates place list 24 to reflect the child of parent 17 now attending in the absence of the child of parent 15 whose absence created childcare vacancy.

If the center management declines the request to authorize the transaction then a message is sent to mobile device 16 indicating that the transaction has been declined. The vacancy will still stay open until another parent 17 elects to fill the vacancy and the transaction is approved for the other parent 17, or until parent 15 takes the offer of an available place down.

Software executed on computer terminal 18 is updated to reflect the child of parent 17 filling the childcare vacancy so that the center management can initiate place setup for the child, if it is the first time the child is attending childcare facility 12. The child then attends childcare facility 12 in lieu of the enrolled child of parent 15. Once the swap occurs, the childcare facility may access all enrolment details and parent details pertaining to the child filling the vacancy.

It will be appreciated that the steps described above may be performed in a different order, varied, or some steps added or omitted entirely without departing from the scope of the disclosure. For example, the childcare facility may be presented with an option to “acknowledge/approve” the swap. Alternatively, the childcare facility can configure the approval process to an “auto-approve” setting whereby all swaps are approved. Further, if desired, an auto-approve setting may be provided for selected criteria (e.g., age, credit history (if available), gender).

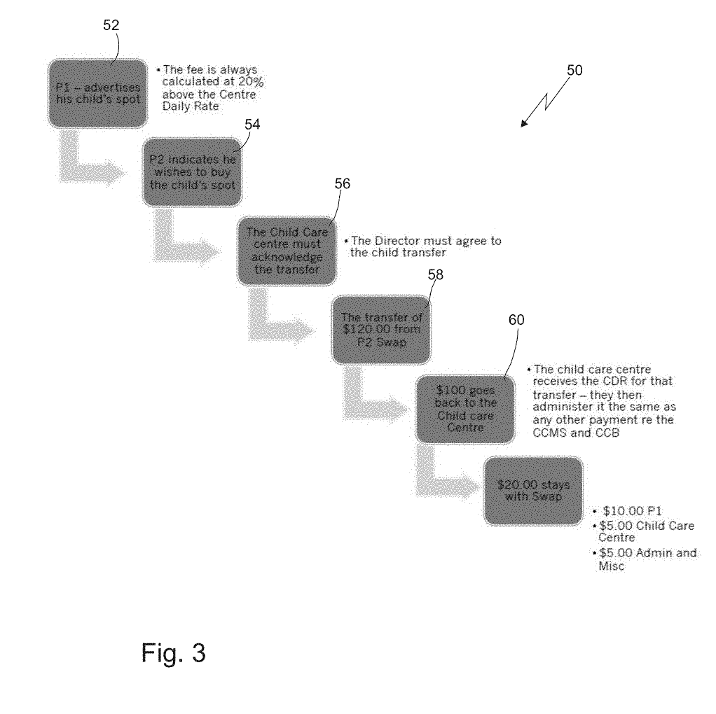

FIG. 3 shows a sequence of events 50 for filling the vacancy at the childcare and an example of an associated financial transaction.

A vacancy at childcare facility 12 is advertised by sending notifications to parents 17 at step 52. The vacancy attracts a fee of $120 per day to fill. The fee of $120 is calculated as 20% above the normal daily rate for a child to attend childcare facility 12. The example of a $120 fee and the 20% surcharge is used as one example only, other fees and surcharges may be used and not always calculated at 20%.

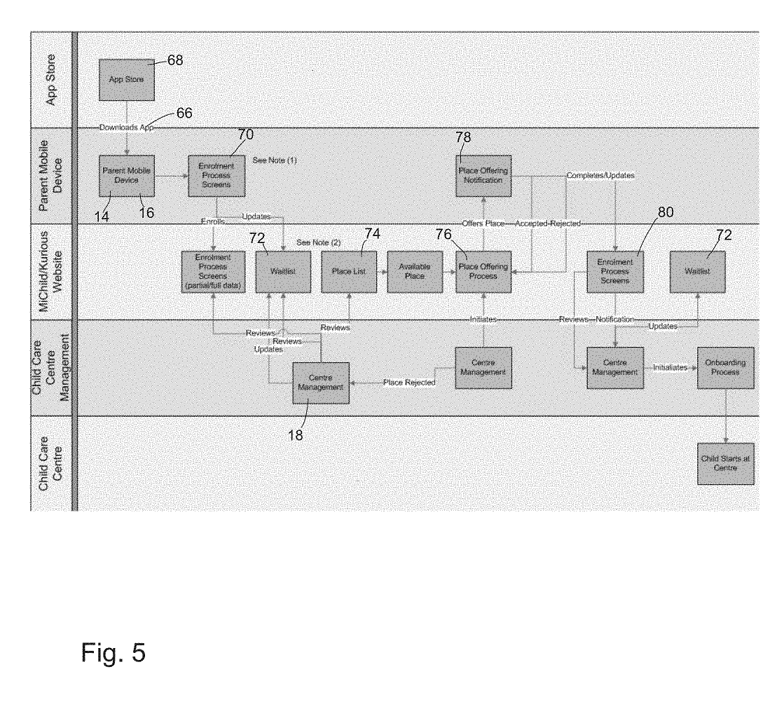

One of the parents 17 claim the available vacancy at step 54. Parent 17 claiming the vacancy is referred to as “P2” in FIG. 5. Parent 15 who makes the vacancy available due to absence of their child is referred to as “P1” in FIG. 5.

Childcare facility 12 authorises the proposed transaction for P2 to fill P1's vacancy at step 56 by agreeing to the transfer. Authorization of the transaction triggers a financial transaction process where P2 is prompted to pay the $120 fee as indicated at 58.

The $120 fee is received by a merchant associated with the administrator of system 10. System 10 apportions the $120 received as follows: $100 is paid to childcare facility 12 as indicated at 60; $10 is credited to P1's account; $5 is credited to childcare facility 12's account; and $5 goes to the administrator for administrative fees.

The $100 payment paid to childcare facility 12 is given the attribution of the parent 17 details so the center facility 12 can process the payment, through their preferred childcare management system, against that parent's account.

All financial transaction details are registered and stored within a database of server 20 and is available for review via mobile devices 14, 16 and computer terminal 18.

The parent 15 with the absent child is incentivised to use system 10 through the payment that is made as a percentage of the transaction fee. The childcare facility 12 is incentivised in two ways. Firstly through the automatic management of the center's waitlists: matching waitlisted children against available spaces identified through child absences, the centers are able to be paid not only for the child who is absent but also now for the child who will fill that spot. Secondly, the centers are incentivised through an additional revenue stream, as they also receive a percentage payment on every transaction fee.

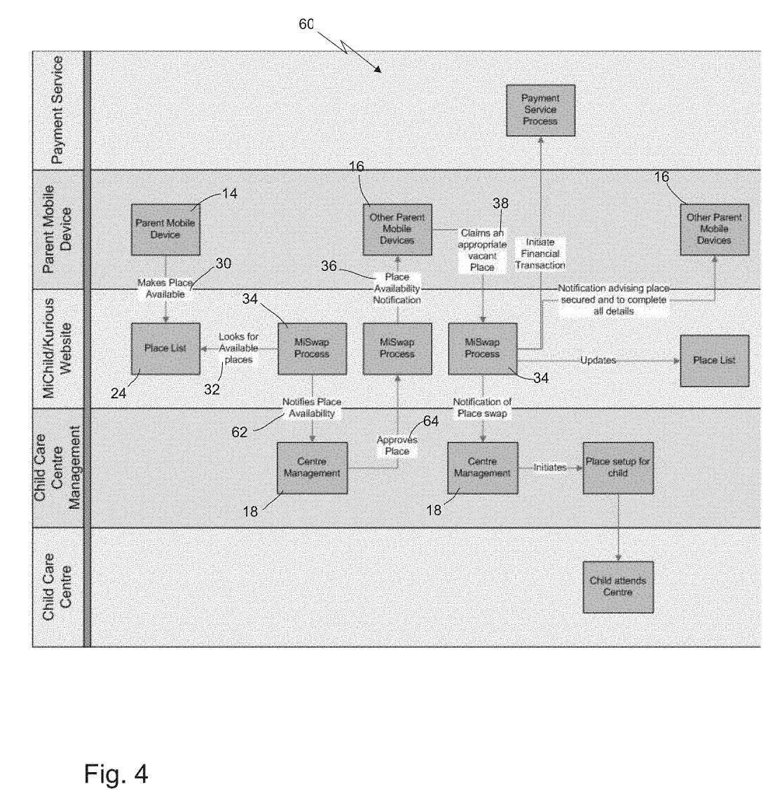

FIG. 4 shows another embodiment of a flow process 60 for filling a vacancy at childcare facility 12. Process 60 is the similar to process 28, the only difference being approval required from center management before place availability notifications 36 are sent to mobile devices 16 of parents 17. The software execute at terminal 18 may include a selection feature to allow for this additional approval. The selection of this feature is communicated to server 20 so that place availability notifications 36 are not sent out without the approval or authorization from terminal 18.

In FIG. 4, the same reference numerals are used to indicate steps and features of process 60 which are the same as the steps and features of process 28 indicated in FIG. 2.

System management software 34 executed on server 20 notifies computer terminal 18 at step 62 that a childcare vacancy has been made available by parent 15. Center management approves or authorises the available childcare place at step 64 to be broadcast by push notification to mobile devices 16 of parents 17 before place availability notification 36 is sent. No further approval or authorization is required by center management via terminal 18 for the transaction to proceed.

Referring to FIG. 5, parents 15, 17 download 66 and install the Swap App on their mobile devices 14, 16 from App store 68.

Parents 15, 17 are required to complete an enrolment process 70 via a user interface presented by the Swap App on the screen of phone 14, 16. Enrolment process 70 prompts the parent to create a profile by populating fields for the parent's contact details. Enrolment process 70 further requires parent 15, 17 to enter account information for receiving or paying a fee for a transaction conducted via system 10.

Enrolment process 70 requires basic waitlist and demographic information, as well as the following enrolment information: a generic childcare center enrolment form; child birth date; latest copy of the child's Immunization Certificate; and child's Birth Certificate.

Enrolment process 70 prompts parents 15, 17 to indicate the childcare days they require, their preferred childcare center for enrolment, the age of the child, etc. Enrolment process 70 prompts parents 15, 17 to indicate if they want to participate in a childcare vacancy filling program as discussed with reference to FIGS. 1 to 4.

Based on the data entered at enrolment process 70, parents 15, 17 are entered onto a waitlist 72 and a place list 74. Waitlist 72 and place list 74 may be a single list saved on server 20.

Center management reviews waitlist 72 and place list 74 via computer terminal 18 connected to server 20. Center management 38 is able to update waitlist 72.

Center management initiates a place offering process 76 via server 20. Parents 15, 17 receive a place offer notification 78 on their mobile devices 14, 16 that they have been offered a place at childcare facility 12. Parents 15, 17 may accept or reject the placement offer. If the offer is accepted the parents 15, 17 are prompted to complete or update their details via a further enrolment process 80. Waitlist is updated after enrolment is completed to remove the days now allocated to the child from the waitlist.

Parent 17 is able to pre-book days via a pre-booking calendar in the Swap App against waitlisted childcare centers. Similarly, parent 17 is able to pre-book days via the pre-booking calendar for other centers where he/she may want childcare in the future: for example, if parent 17 is working interstate and requires care over a certain time frame in a certain postcode.

The pre-booking functionality enables a parent to arrange childcare in locations where the parent may be travelling in advance of the traveling date. Parent 17 is able to enter into the pre-booking calendar in the Swap App settings that the parent requires childcare in a specific location over a specific time.

Referring to FIG. 6, a screenshot of a graphical user interface 82 of the Swap App executed on mobile device 14 is shown. User interface 82 shows a calendar 84 and an instruction message 86 on how to select days on calendar 84 to indicate that the parent 15″s child will be sick or away and thus not able to attend childcare facility 12. Days on calendar 84 are selected by touch, simply by tapping on a specific date or dragging the user's finger across multiple dates.

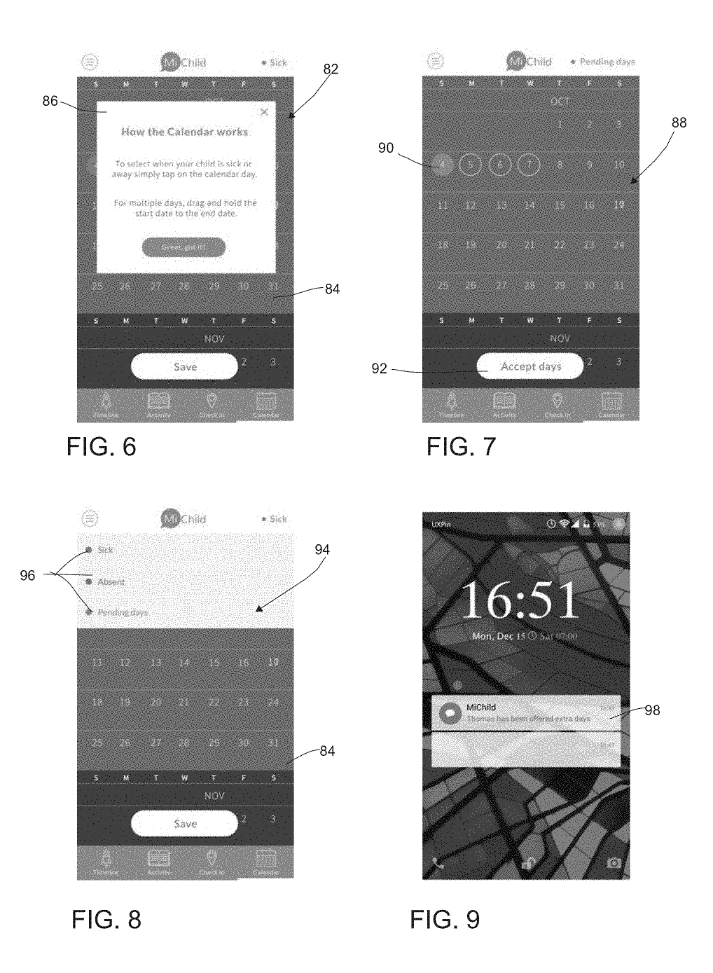

Referring to FIG. 7, a screenshot of a graphical user interface 88 of the Swap App executed on mobile device 16 is shown. Days 90 which may be accepted by parent 17 for their child to attend childcare facility 12 is highlighted. Parent 17 may accept these days by selecting the day(s) on the calendar and pressing “Accept days” button 92.

Referring to FIG. 8 a screenshot of a graphical user interface 94 of the Swap App executed on mobile device 14, 16 is shown. Different categories 96 of days that may be selected via calendar 84 is shown.

FIG. 9 shows a screenshot of a graphical user interface of mobile device 16. A push notification 98 is displayed on the screen of mobile device 16. Push notification 98 indicates that the child of parent 17 is being offered a vacancy that has become available at childcare facility 12.

Through the Swap App, the parent is able to purchase attendance at any childcare center on his/her waitlist registration. This is a way for a parent to get a real understanding of the specific childcare center's operations, community, practices and processes, prior to taking a permanent position in any one of the centers.

System 10 operates as a stand-alone booking system that does not need to interface with existing childcare management systems or other childcare software. This allows system 10 to operate in a software agnostic environment. An interface may be built to an external child care management system, if required by childcare facility 12.

The Swap App may use mapping technology to identify childcare centers in an areas requested in the participant's settings and booking request. For example, the Swap App may request the user to enter a postcode for searching available childcare centers. The Swap App will then display all childcare centers within that postcode that is registered with server 20.

The Swap App has an interface with blogs and forums and other forms of online communication. Additionally the Swap App may provide a trading platform for parents to buy, swap, sell, give away goods and services utilising the full capabilities of the payment portal.

While all parents with children on waitlists fill in an application form for that particular childcare center, childcare centers participating with the Swap technology prompt the parent to download the App and register their details.

The Swap technology permits for “transient bookings” whereby when P2 is required, for example, to travel interstate for work, she is able to adjust the profile settings to indicate that she requires childcare in a specific location over a specific date range.

The foregoing description is by way of example only, and may be varied considerably without departing from the scope of the disclosure. For example, a parent seeking a place in a childcare facility (P2) may initiate the vacancy fulfillment process. The platform and App may be configured so that P2 may initiate the process by indicating on the calendar (exemplified in FIGS. 6-8) in the App that they are looking for a particular day (for example, January 4) in a particular center or centers. A list of centers may be dynamically presented for selection based on the present geo-location of P2, and/or from a preferred center list which may be assembled by P2. Once a day is made available from a parent vacating a position in a childcare facility that is on P2's list, the swap (and if desired, financial transaction) is initiated. The swap may also, or alternatively, be initiated based on other criteria, such as child age, gender, calendar date, prior care history, user review, etc.

The platform preferably utilizes a graphic user interface on a mobile device. It will be appreciated that the platform, system and method described above may be modified to utilize chatbot technology, and voice-automated commands to facilitate a hands-free mode of interaction, for example, while a parent or user is in a vehicle. It will further be appreciated that the platform, system and method may be adapted for use in on-board vehicle computer systems, which may optionally interact with the vehicle's navigation system and on-board GPS and communication systems. Vehicle license and/or registration details may be dynamically provided to a childcare facility on the approach of the vehicle in the vicinity of the childcare facility, or within a predetermined radius of the childcare facility to enable the childcare facility to ready a child for departure from the facility. It will be appreciated that a variety of identifying vehicle details may be provided, such as, for example only, vehicle type, make, model, and color.

The Swap App may be configured as a stand-alone app and function independently of any central server. For example, the App may operate in a peer-to-peer relationship with other mobile devices, or a combination of a peer-to-peer relationship with other mobile devices with occasional contact with a central server (e.g., once a day, once a week, once a month, etc.).

The computer web platform and system may be configured to incorporate Artificial Intelligence (AI). The particular coding to implement AI in the childcare field would be understood by a person of ordinary skill in the art, and for simplicity, is not detailed herein. AI may be configured to prompt the Swap App use based on one or more of geo-location data, interaction with other databases (e.g., calendar database), real-time user physical actions and/or conditions (e.g., body temperature, perspiration, orientation of mobile device as it is being held by the user, etc.), and cumulative behaviour pattern recognition. For example only, a system processor (or even local processor such as included in a smartphone or on-board vehicle computer) may be configured with AI so that a parent's calendar is queried and a childcare vacancy search is conducted for childcare should a parent be scheduled to be out of the area for a given day or time. In another example, if a parent regularly attends a social function once every two weeks, the AI-configured processor will recognize the pattern and prompt the parent to enable a childcare search. In a further example, if the parent purchases an airline ticket for themselves, but not an associated child, the AI-configured processor will prompt the parent for a child care search, optionally for the date range of the intended trip. The AI-configured processor is preferably configured with dynamic pattern recognition and programmed to permit the processor to predict the need for childcare based on a parent's schedule (e.g., consulting a parent's personal electronic calendar), outside events (e.g., airline ticket purchase, movie ticket purchase, or sign-up for a seminar or workshop), and/or physical indications (e.g., body conditions or actions to signify a desired action to be taken by the system).

The AI-configured processor is preferably configured to detect and react to the physical, physiological and behavioural actions of the user, similar to the operation of wearable technologies such as Apple's iWatch™. For example, the AI-configured processor may detect bio-data such as a faster heart rate and perspiration when used in combination with one or more sensors (located in a wearable device such as a smartwatch, or in a smartphone when adjacent the user's body). The AI-configured processor may utilize the bio-data; detected actions such as a phone number dialed and/or number of calls; and/or scheduled events such as appearing on a calendar meeting request, and optionally together with a geo-location of the user, predict or suggest a user need for childcare. For example, detection of the user being home with a child may indicate that the child is on a waitlist, particularly if a scheduled event appears on the user's electronic calendar for the day.

The features described with respect to one embodiment may be applied to other embodiments, or combined with, or interchanged with, the features of other embodiments without departing from the scope of the present invention.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A non-transitory computer-readable storage medium comprising instructions stored therein, which when executed by one or more processors, cause the one or more processors to perform operations comprising:
creating a first profile on a database, the first profile including contact data of a first parent or guardian of a child who is enrolled at the childcare facility;
creating a second profile on the database, the second profile including contact data of a second parent or guardian of a child in need of childcare;
receiving, from a personal computing device associated with the first parent or guardian, a notification that the enrolled child of the first parent or guardian will be absent during a time period in which the enrolled child is scheduled to attend the childcare facility;
sending, to a personal computing device associated with the second parent or guardian, an alert notification of an available time period being vacated by the absence of the enrolled child without providing a parallel notification to a computing device associated with the childcare facility;
receiving, from the personal computing device associated with the second parent or guardian, an acceptance notification that a child associated with the second parent or guardian will occupy at least a portion of the time period being vacated by the absent child; and then
receiving, from the computing device associated with the childcare facility, an authorization notification accepting a placement of the child of the second parent or guardian in lieu of the absent enrolled child.

2. The non-transitory computer-readable storage medium of claim 1, further comprising sending confirmation to the personal computing device associated with the second parent or guardian that placement of the child of the second parent or guardian in lieu of the absent enrolled child has been accepted by the computing device associated with the child care facility.

3. The non-transitory computer-readable storage medium of claim 1, further comprising a payment service process being initiated after the authorization notification is received, for the second parent or guardian to pay a fee for the placement of the child of the second parent or guardian.

4. The non-transitory computer-readable storage medium of claim 3, wherein at least part of the fee is paid to the first parent or guardian.

5. The non-transitory computer-readable storage medium of claim 3, wherein at least part of the fee is paid to an administrator of the method.

6. The non-transitory computer-readable storage medium of claim 1, further comprising updating a place list, listing booked places at the childcare facility, with details of the child of the second parent or guardian attending in lieu of the absent enrolled child, after the authorization notification is received.

7. The non-transitory computer-readable storage medium of claim 1, wherein the alert notification is only sent to the second parent or guardian if the child of the second parent or guardian meets certain criteria.

8. The non-transitory computer-readable storage medium of claim 7, wherein the criteria is that the child is within a defined age range or that the child ordinarily attends a specific class at the childcare facility.

9. A system for identifying and fulfilling a childcare vacancy, comprising:
a central server including a database with a first profile including contact data of a first parent or guardian of a child who is enrolled at a childcare facility and a second profile including contact data of a second parent or guardian of a child in need of childcare;
a computing device associated with the childcare facility;
a personal computing device associated with the first parent or guardian, said central server operable to receive a notification that the enrolled child of the first parent or guardian will be absent during a time period in which the enrolled child is scheduled to attend the childcare facility;
a personal computing device associated with the second parent or guardian, said central server operable to send an alert notification to said personal computing device associated with the second parent or guardian of an available time period being vacated by the absence of the enrolled child without providing a parallel notification to said computing device associated with the childcare facility.

10. A method for filling a vacancy at a childcare facility, the method comprising:
creating a first profile on a computer database, the first profile including contact data of a first parent or guardian of a child who is enrolled at the childcare facility;
creating a second profile on the computer database, the second profile including contact data of a second parent or guardian of a child in need of childcare;
receiving, from a personal computing device associated with the second parent or guardian, a pre-booking request for a placement at the childcare facility based on an unannounced absence of an enrolled child at the childcare facility;
receiving, from a personal computing device associated with the first parent or guardian, an absence notification that the enrolled child of the first parent or guardian will be absent during a time period in which the enrolled child is scheduled to attend the childcare facility; and
sending, to the personal computing device associated with the second parent or guardian, an acceptance notification that the pre-booking request is fulfilled after receiving the absence notification from the personal computing device associated with the first parent or guardian.

11. The method of claim 10, further comprising initiating a payment service process after the acceptance notification is sent, for the second parent or guardian to pay a fee for the placement of the child of the second parent or guardian.

12. The method of claim 11, wherein at least part of the fee is paid to the first parent or guardian.

13. The method of claim 10, further comprising updating a place list, listing booked places at the childcare facility, with details of the child of the second parent or guardian attending in lieu of the absent enrolled child, after the acceptance notification is sent.
